(19) United States
(12) Patent Application Publication
(10) Pub. No.: US 2011/0094594 A1
(43) Pub. Date: Apr. 28, 2011

(54) Reducing Agent Tank That is Intended for Providing a Reducing Agent to an Exhaust Gas System and That Has a Check Valve

(75) Inventor: Thomas BAUMEISTER, Muenchen (DE)

(73) Assignee: Bayerische Motoren Werke Aktiengesellschaft, Muenchen (DE)

(21) Appl. No.: 12/984,917

(22) Filed: Jan. 5, 2011

Related U.S. Application Data
(63) Continuation of application No. PCT/EP2009/004415, filed on Jun. 18, 2009.

(30) Foreign Application Priority Data
Jul. 23, 2008 (DE) 10 2008 034 223.8

(51) Int. Cl. F17D 1/00; F17D 3/00

(52) U.S. Cl. 137/2; 137/624.11

(57) ABSTRACT

A reducing agent tank, which is intended for providing a reducing agent to an exhaust gas system and which has a first tank for storing the reducing agent, a second tank for storing the reducing agent, a line for recirculating the reducing agent from the second tank into the first tank and a check valve for closing the line in a selective fluid-tight manner, includes a diagnostic device, with which an incorrect function of the check valve can be detected.

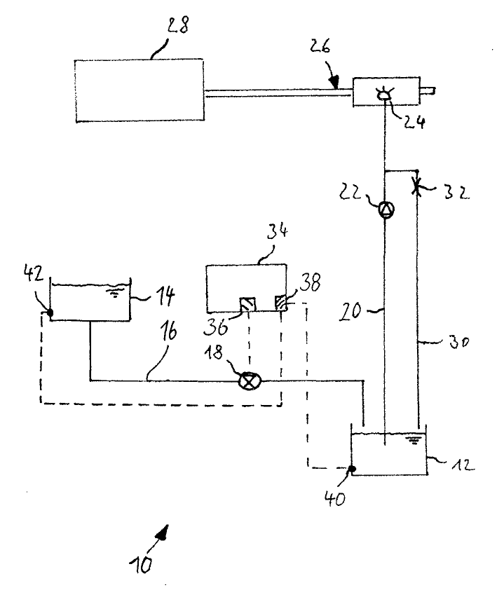

### CROSS-REFERENCE TO RELATED APPLICATIONS

This application is a continuation of PCT International Application No. PCT/EP2009/004415, filed Jun. 18, 2009, which claims priority under 35 U.S.C. §119 from German Patent Application No. DE 10 2008 034 223.8, filed Jul. 23, 2008, the entire disclosures of which are herein expressly incorporated by reference.

### BACKGROUND AND SUMMARY OF THE INVENTION

The invention relates to a reducing agent tank that is intended for providing a reducing agent to an exhaust gas system and that has a first tank for storing the reducing agent, a second tank for storing the reducing agent, a line for recirculating the reducing agent from the second tank into the first tank and a check valve for closing the line in a selective fluid-tight manner.

Furthermore, the invention relates to a method that is intended for providing a reducing agent to an exhaust gas system and that includes the following acts: storing the reducing agent in a first tank, storing the reducing agent in a second tank, recirculating the reducing agent from the second tank into the first tank by way of a line, and shutting off the line by way of a check valve.

In modern internal combustion engines, which are equipped, in particular, with a diesel engine, in order to reduce the nitrogen oxide content in the exhaust gas, a catalytic reduction is introduced by way of a selective catalytic reaction. The nitrogen oxides are reduced to nitrogen and water by way of fluid reducing agents—for example, an aqueous urea solution.

In order to store the fluid reducing agent, reducing agent tanks are used that are designed as multi-tank systems. In this case the reducing agent is stored in an active tank as the first tank and at least one passive tank as the second tank. In order to provide the reducing agent, the reducing agent must be conveyed, or rather pumped, inter alia, from the passive tank into the active tank. To this end, there is a line with a dedicated check valve. The check valve is activated relatively infrequently, as a result of which crystals of the reducing agent can form in the check valve. These crystals jam the check valve and consequently can result in an undesired failure of the associated system.

The object of the invention is to provide a reducing agent tank and a method that is intended for providing a reducing agent and with which the aforementioned drawbacks are overcome and, in particular, that ensures, a reduction of the nitrogen oxides in the exhaust gas under all environmental conditions and over the entire service life of the reducing agent tank.

The invention achieves this and other objects by providing a reducing agent tank and method of operating same for providing a reducing agent to an exhaust gas system and that has a first tank for storing the reducing agent, a second tank for storing the reducing agent, a line for recirculating, i.e., conveying, the reducing agent from the second tank into the first tank, and a check valve for closing the line in a selective fluid-tight manner. A diagnostic device is operatively configured for detecting an incorrect function of the check valve.

In contrast to known systems for providing a reducing agent to an exhaust gas system, in particular an internal combustion engine of a motor vehicle, the invention provides that the rarely activated check valve for closing the line in a selective fluid-tight manner be diagnosed—that is, monitored with respect to its function. This approach makes it possible to detect at an early stage a malfunction of the check valve—for example, a partial or total failure—and to indicate in a suitable way to the user of the motor vehicle, which is equipped with the reducing agent tank of the invention, by way of a display unit that maintenance work is required.

In a first advantageous further development of the reducing agent tank according to the invention, the diagnostic device is assigned a device for measuring the amount of filling. This filling amount measuring device is intended for the first tank and can be used to measure the filling amount in the first tank. The filling amount measuring device can measure any filling amount that is fed through the check valve into the first tank. This measured filling amount can be compared with a calculated filling amount that follows or should follow from, for example, the opening duration of the check valve. The filling amount in the first tank is measured preferably on the basis of a particular event—that is, for example, an initial tank filling—or on the basis of the last process of recirculation, i.e., the conveying from the second tank to the first tank. Then, the particular event represents a reference that can be used for calculating the change in the filling amount. Reference can be made to this reference as early as when just a single deviating filling level is determined with the filling amount measuring device at the first tank. The difference between the reference value and the measured and/or determined filling level makes it possible to draw conclusions about a correct or incorrect function of the check valve. If, for example, the filling amounts in the first tank before and after a process of recirculation (conveying) do not differ, the obvious conclusion is a malfunction of the check valve.

In a second inventive further development of the reducing agent tank according to the invention, the diagnostic device is assigned a filling amount measuring device that is intended for the second tank and with which the filling amount in the second tank can be measured. Then, the procedure is basically analogous to the one described above for the first further development and its method for measuring the filling amount in the first tank. If additionally to the first tank the second tank does not show a difference in the filling amount, after the process of recirculation, then a malfunction of the check valve can be inferred and simultaneously it can be concluded that the monitoring system is fully functional. In this context, the following four diagnostic states are determined:
(1) if the filling amount in the first tank has increased after a process of recirculation while the filling amount in the second tank has diminished, then the whole system is in order;
(2) if the filling amount in the first tank has increased after an initiated process of recirculation while the filling amount of the second tank remained essentially unchanged, then the diagnostic device is not in order;
(3) if neither the filling amount in the first tank has changed after an initiated process of recirculation nor has the filling amount of the second tank changed, then most likely the check valve is defective; and
(4) if the filling amount in the first tank has not changed after a process of recirculation, while the filling amount of the second tank has diminished, then the diagnostic device is not in order or there is a leakage between the first tank and the second tank, e.g., leak in a pipe or valve.

In a third further development according to the invention, the diagnostic device is assigned a time measuring device, by which the time duration of the open check valve can be measured. On the basis of this time duration an amount of flow per unit of time through the line can be calculated (if the line throughput is known in principle). The filling level, which can be expected from this amount of throughflow, in the first tank is compared with the actual filling level, and then on the basis of this comparison, it is possible to draw conclusions about the faulty function of the check valve.

In a fourth further development according to the invention, the diagnostic device is assigned a device for determining the amount of filling. With this filling amount determining device it is possible to calculate the amount of filling that can be expected in one of the tanks. Then the expected filling amount can be compared in the diagnostic device with the actually measured value, and on the basis of this comparison, conclusions can be drawn about the faulty function of the check valve.

In accordance with the above described system, an inventive method for providing a reducing agent to an exhaust gas system comprises the acts of: (a) storing a reducing agent in a first tank, (b) storing a reducing agent in a second tank, (c) recirculating the reducing agent from the second tank into the first tank by way of a line and shutting off the line by use of a check valve, and (4) diagnosing the function of the check valve.

In accordance with the aforementioned first further development, the method comprises preferably the act of diagnosing a measurement of the filling amount in the first tank.

According to the aforementioned second further development, the method comprises preferably the act of diagnosing a measurement of the filling amount in the second tank.

In accordance with the aforementioned third further development, the method according to the invention comprises preferably the act of diagnosing a measurement of the time duration of the open check valve.

In accordance with the aforementioned fourth further development, a filling amount, which is to be expected in the tank, is calculated in the course of determining at least one filling amount in at least one tank.

Other objects, advantages and novel features of the present invention will become apparent from the following detailed description of one or more preferred embodiments when considered in conjunction with the accompanying drawing.

### BRIEF DESCRIPTION OF THE DRAWING

The sole FIGURE is a highly simplified schematic circuit diagram of one embodiment of an inventive reducing agent tank, in addition to the exhaust gas system and the internal combustion engine.

### DETAILED DESCRIPTION OF THE DRAWING

The FIGURE shows a reducing agent tank 10 that is intended for providing a reducing agent and that includes, for purposes here, a first tank 12 and a second tank 14. The first tank 12 is also referred to as the “intake tank” or “active tank” and serves as the reducing agent accumulator, from which the reducing agent can be taken under all environmental conditions (in particular, even in the case of frost). The second tank 14 is also referred to as the “storage tank” or “passive tank” and serves only to store the “additional reducing agent.”

Between the tanks 12 and 14 there runs a line 16, which is assigned a check valve 18. This check valve 18 has the function of shutting off in a selective manner the recirculation of the reducing agent from the second tank 14 into the first tank 12.

Furthermore, there is an intake line 20, through which the reducing agent can be drawn in and conveyed with a pump 22. The pump 22 serves to pump the reducing agent from the first tank 12 to a metering module 24. The engineering object of the metering module 24 is to inject the reducing agent into the associated exhaust gas system 26, so that the reducing agent can facilitate the reducing effect, described above, in the exhaust gas system. To this end, the exhaust gas is fed to the exhaust gas system 26 from an internal combustion engine 28. The exhaust gas contains those nitrogen oxides that are converted to nitrogen and water by use of the reducing agent, which in this case is an aqueous urea solution.

A return line 30 branches-off from the intake line 20 in the direction of flow downstream of the pump 22. In this respect the pump 22 is configured in such a manner that it draws in from the tank 12 not only the reducing agent, required for injection into the metering module 24, but also excess reducing agent. Such excess reducing agent is fed through the return line 30 back again into the first tank 12. In this case the return line 30 has a diaphragm 32, which limits the amount of reducing agent that is fed through the return line 30 and, in so doing, defines the pressure of the reducing agent prevailing in the metering module 24.

Furthermore, the check valve 18 is coupled to a diagnostic device 34. The diagnostic device 34 serves to detect an incorrect function of the check valve 18. This feature is implemented, first of all, by arranging a time measuring device 36 inside the diagnostic device 34. The time measuring device 36 is coupled to the check valve 18 and measures the time duration of an open check valve 18. On the basis of this time duration, it is possible to calculate for the single opening event of the check valve 18 the resulting amount of flow through the line. Then the filling level, which is to be expected from this amount of throughflow, in the first tank 12 is compared with the actual filling level, and on the basis of this comparison, it is possible to draw conclusions about the operational state of the check valve 18, such as whether it is faulty or normal.

Furthermore, the diagnostic device 34 is assigned a device 38 for determining the amount of filling. The filling amount determining device 38 is coupled to a filling amount measuring device 40 on the first tank 12 as well as to a filling amount measuring device 42 on the second tank 14. With these filling amount measuring devices 40 and 42, which are configured in the manner of filling amount sensors or rather fill level sensors, the filling levels in the tanks 12 and 14 are measured. This measurement is carried out, in particular, on the basis of a particular event—that is, the initial tank filling—or on the basis of the last process of recirculation. On the basis of these filling amounts, a diagnosis is made, as described above, with respect to a correct function of the check valve 18.

Table of Reference Numerals

| | |
|---|---|
| 10 | reducing agent tank |
| 12 | first tank |
| 14 | second tank |
| 16 | line |
| 18 | check valve |
| 20 | intake line |
| 22 | pump |
| 24 | metering module |
| 26 | exhaust gas system |
| 28 | internal combustion engine |
| 30 | return line |
| 32 | diaphragm |
| 34 | diagnostic device |
| 36 | time measuring device |
| 38 | filling amount determining device |
| 40 | filling amount measuring device |
| 42 | filling amount measuring device |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A reducing agent tank for providing a reducing agent to an exhaust gas system, comprising:
a first tank for storing the reducing agent;
a second tank for storing the reducing agent;
a line operatively configured for recirculating the reducing agent from the second tank into the first tank;
a check valve operatively configured for selectively closing the line in a fluid-tight manner; and
a diagnostic device operatively configured for diagnosing an operational condition of the check valve.

2. The reducing agent tank according to claim 1, wherein the diagnostic device includes a first filling amount measuring device operatively configured for measuring a filling amount of the first tank.

3. The reducing agent tank according to claim 1, wherein the diagnostic device includes a filling amount measuring device operatively configured for measuring a filling amount of the second tank.

4. The reducing agent tank according to claim 2, wherein the diagnostic device includes a second filling amount measuring device operatively configured for measuring a filling amount of the second tank.

5. The reducing agent tank according to claim 1, wherein the diagnostic device includes a time measuring device operatively configured for measuring operational times of the check valve.

6. The reducing agent tank according to claim 4, wherein the diagnostic device includes a time measuring device operatively configured for measuring operational times of the check valve.

7. The reducing agent tank according to claim 5, wherein the diagnostic device includes a filling amount determining device by which a filling amount, that is expected in one of the first and second tanks, is calculatable.

8. The reducing agent tank according to claim 6, wherein the diagnostic device includes a filling amount determining device by which a filling amount, that is expected in one of the first and second tanks, is calculatable.

9. A method of operating a reducing agent tank that provides a reducing agent to an exhaust gas system, the method comprising the acts of:
storing reducing agent in a first tank;
storing reducing agent in a second tank;
recirculating the reducing agent from the second tank into the first tank by way of a line;
controlling a shut-off of the line by way of a check valve; and
diagnosing a function of the check valve.

10. The method according to claim 9, wherein the diagnosing act comprises the act of measuring a filling amount in the first tank.

11. The method according to claim 10, wherein the diagnosing act further comprises the act of measuring a filling amount in the second tank.

12. The method according to claim 9, wherein the diagnosing act comprises the act of measuring a time duration during which the check valve is opened.

13. The method according to claim 11, wherein the diagnosing act further comprises the act of measuring a time duration during which the check valve is opened.

14. The method according to claim 12, wherein an expected filling amount for a tank is calculated based on the measured time duration during which the check valve is opened.

15. The method according to claim 13, wherein an expected filling amount for a tank is calculated based on the measured time duration during which the check valve is opened.

16. A method for diagnosing operation of a check valve arranged in a recirculation line between a first tank storing a reducing agent and a second tank storing a reducing agent, the first and second tanks being part of a reducing agent tank system that provides a reducing agent to an exhaust gas system, the method comprising the acts of:
measuring a fill amount in one of said tanks;
measuring an opening duration of the check valve when filling said one tank;
calculating an expected fill amount as a function of the measured opening duration; and
comparing the measured fill amount with the calculated fill amount to diagnose the function of the check valve.
